(19) United States
(12) Patent Application Publication
(10) Pub. No.: US 2016/0272120 A1
(43) Pub. Date: Sep. 22, 2016

(54) Rear Seat Accessible Vehicle Storage Compartment

(71) Applicant: Atieva, Inc., Menlo Park, CA (US)

(72) Inventors: Vincent George Johnston, Half Moon Bay, CA (US); Peter Dore Rawlinson, Worcestershire (GB); Hugh Robinson, Redwood City, CA (US)

(73) Assignee: Atieva, Inc., Menlo Park, CA (US)

(21) Appl. No.: 14/663,517

(22) Filed: Mar. 20, 2015

(51) Int. Cl. B60R 7/04; B60N 3/00; B60N 3/10; B60R 11/00; B60R 11/02

(52) U.S. Cl. CPC B60R 7/04; B60R 11/00; B60R 11/0229; B60N 3/104; B60N 3/001; B60R 2011/0007; B60R 2011/0276

(57) ABSTRACT

A retractable storage compartment that is accessible by the passengers in the rear portion of a vehicle's passenger cabin is provided. The storage compartment, which is integrated into the vehicle's center console, is mounted on a guide assembly in order to allow a rear passenger to easily open or close the compartment. The compartment may be configured as a simple storage area, or equipped with any of a variety of features such as an insulated ice chest, a refrigerator unit, a fold-out desk, etc. In addition to providing rear passenger access, the compartment may be configured to allow the passengers seated in the front of the car to access the compartment using a secondary, top-mounted door.

### FIELD OF THE INVENTION

The present invention relates generally to vehicles and, more particularly, to a storage compartment integrated into the center console of a vehicle's passenger cabin.

### BACKGROUND OF THE INVENTION

Luxury vehicles offer a number of user amenities that provide the driver with a more enriching experience, and one which attempts to cater to each driver and their particular wants and needs. For example, many cars allow the driver to select between multiple driving modes by simply rotating a knob or pushing a button, where each driving mode alters a variety of vehicle characteristics ranging from throttle response to suspension set-up. Another feature that has become commonplace among luxury vehicles is the ability to preset and memorize the various aspects of the driver's seat, e.g., seat position, seat height, seatback incline, lumbar support, seat cushion angle and seat cushion length. Once preset, recorded in memory and assigned to a particular user, the preset settings may be re-obtained by simply pushing a button within the car or activating the car with a user assigned key fob. Outside mirrors and steering wheel position may also be linked to the same memory, thus allowing the vehicle to automatically adjust the driver's seat, steering wheel and mirror placement once a particular driver is identified.

In addition to car features that improve the driving experience, many luxury vehicles also include a variety of amenities that provide a more luxurious atmosphere for the passengers as well as the driver. Some of these features, such as adjustable air shocks and soundproofing, are intended to help isolate the passenger cabin from the ambient environment. Other features such as rear cabin air vents, an improved sound system, rear heated seats, and integrated DVD displays are designed to provide the rear-seated passengers with an extremely comfortable, home-like environment. While these amenities do insure passenger comfort, the limited space available in a conventional vehicle hinders vehicle designers from providing passengers with the desired level of luxury. Accordingly, the present invention is intended to provide an additional level of comfort and convenience to the rear seat passengers.

### SUMMARY OF THE INVENTION

The present invention provides a passenger accessible storage system that is mounted within a vehicle's passenger cabin. The storage system, which is comprised of a storage compartment mounted to a guide track assembly, is movable via the guide track assembly between a first, stored position and a second, deployed position. In the first, stored position the storage compartment is stored within a center console, where the center console is located between the front left and front right seats comprising the first row of seats within the vehicle's passenger cabin. In the second, deployed position the storage compartment extends rearward towards the second row of seats within the vehicle's passenger cabin.

In one aspect, the storage compartment may only be open and accessible when it is in said second, deployed position.

In another aspect, the center console may further include an arm rest that is hingeably coupled to the center console and movable between a first, open position and a second, closed position. In this configuration preferably the storage compartment is accessible via an opening in an upper portion of the center console when the arm rest is in the first, open position and the storage compartment is in the first, stored position, while the storage compartment is not accessible via the opening in the upper portion of the center console when the arm rest is in the second, closed position.

In another aspect, the storage compartment may be further comprised of (i) a fold-out desk that is integrated into the storage compartment such that when the storage compartment is in the first, stored position the fold-out desk is folded up and contained within the storage compartment, and where the fold-out desk can only be unfolded when the storage compartment is in the second, deployed position; (ii) a display integrated into the storage compartment which is connectable to a source device by at least one of a wired connection and a wireless connection, where the display is in a stored position and contained within the storage compartment when the storage compartment is in the first, stored position, and where the display can only be unfolded from the storage compartment and accessed when the storage compartment is in the second, deployed position; (iii) a keyboard integrated into the storage compartment which is connectable to a source device by at least one of a wired connection and a wireless connection, where the keyboard is in a stored position and contained within the storage compartment when the storage compartment is in the first, stored position, and where the keyboard can only be unfolded from the storage compartment and accessed when the storage compartment is in the second, deployed position; (iv) an insulated ice chest; (v) an insulated ice chest with an active refrigeration system; (vi) a lockable lid, where the storage compartment is only open and accessible when the lockable lid is in a first, open position and the storage compartment is in the second, deployed position, and where the storage compartment is not accessible when the lockable lid is in a second, closed position; and (vii) a lid, which may include at least one cup holder, that is slidably coupled to the storage compartment and which is extendible over the second row of seats when the storage department is in the second, deployed position.

In another aspect, a first portion of the guide track assembly may be mounted to a lower surface of the storage compartment and a second portion of the guide track assembly may be mounted to a section of the passenger cabin floor; alternately, a first portion of the guide track assembly may be mounted to a lower surface of the storage compartment and a second portion of the guide track assembly may be mounted to a section of the center console; alternately, the guide track assembly may be comprised of first and second guide track subassemblies, where the first guide track assembly is mounted to a first side of the storage compartment and a first inside surface of the center console, and where the second guide track assembly is mounted to a second side of the storage compartment and a second inside surface of the center console.

In another aspect, the system may further include a spring assembly that is coupled to the storage compartment and which maintains tension on the storage compartment and forces the storage compartment from the first, stored position towards the second, deployed position. The system may also include a latch assembly that maintains the storage compartment in the first, stored position when in a locked position, and allows the spring assembly to force the storage compartment from the first, stored position towards the second, deployed position when in a unlocked position.

In another aspect, the system may further include a positioning system (e.g., an electro-mechanical or hydraulic positioning system) that is coupled to the storage compartment and that is adjustable between a first position that corresponds to the storage compartment being in the first, stored position, and a second position that corresponds to the storage compartment being in the second, deployed position. The system may further include a storage compartment position selector coupled to and controlling operation of the positioning system, where the position selector in a first setting moves the positioning system to the first position and where the position selector in a second setting moves the positioning system to the second position.

A further understanding of the nature and advantages of the present invention may be realized by reference to the remaining portions of the specification and the drawings.

### BRIEF DESCRIPTION OF THE DRAWINGS

It should be understood that the accompanying figures are only meant to illustrate, not limit, the scope of the invention and should not be considered to be to scale. Additionally, the same reference label on different figures should be understood to refer to the same component or a component of similar functionality.

FIG. 1 provides a perspective view of an embodiment of the invention with the storage compartment stored within the vehicle's center console;

FIG. 2 provides a perspective view of the embodiment shown in FIG. 1 with the storage compartment in the extended, i.e., deployed, position;

FIG. 3 provides a side view of the embodiment of the storage compartment shown in FIGS. 1 and 2 in the stored position;

FIG. 4 provides a side view of the embodiment of the storage compartment shown in FIGS. 1 and 2 in the extended position;

FIGS. 5A-5D provide a perspective view of a particular compartment configuration at different stages of deployment; and

FIG. 6 provides a perspective view of an embodiment of the storage compartment of the invention, this view showing a portion of a preferred guide track assembly.

### DESCRIPTION OF THE SPECIFIC EMBODIMENTS

As used herein, the singular forms “a”, “an” and “the” are intended to include the plural forms as well, unless the context clearly indicates otherwise. The terms “comprises”, “comprising”, “includes”, and/or “including”, as used herein, specify the presence of stated features, process steps, operations, elements, and/or components, but do not preclude the presence or addition of one or more other features, process steps, operations, elements, components, and/or groups thereof. As used herein, the term “and/or” and the symbol “/” are meant to include any and all combinations of one or more of the associated listed items. Additionally, while the terms first, second, etc. may be used herein to describe various steps, calculations, or components, these steps, calculations, or components should not be limited by these terms, rather these terms are only used to distinguish one step, calculation, or component from another. For example, a first calculation could be termed a second calculation, and, similarly, a first step could be termed a second step, and, similarly, a first component could be termed a second component, without departing from the scope of this disclosure.

The present invention provides a retractable storage compartment that is accessible by the passengers in the rear portion of a vehicle's passenger cabin. The storage compartment, which is integrated into the vehicle's center console, is closed and preferably hidden from view when retracted, and as such provides a secure area for hiding valuables. In the deployed position the compartment is open and easily accessible by the rear seated passengers. In addition to a simple open storage area, the retractable compartment of the invention may be configured to house any of a variety of features including, but not limited to, a lockable safe, a mini-refrigerator, a fold-out desk, a fold-out eating area, a mini-bar, a fold-out display for use with a computer or DVD player, etc. The configuration for this compartment may be pre-selected by the vehicle's manufacturer, or by an end user. In at least one embodiment, a modular approach is used with the compartment, thus allowing an end user to vary the feature set by simply inserting a different compartment liner.

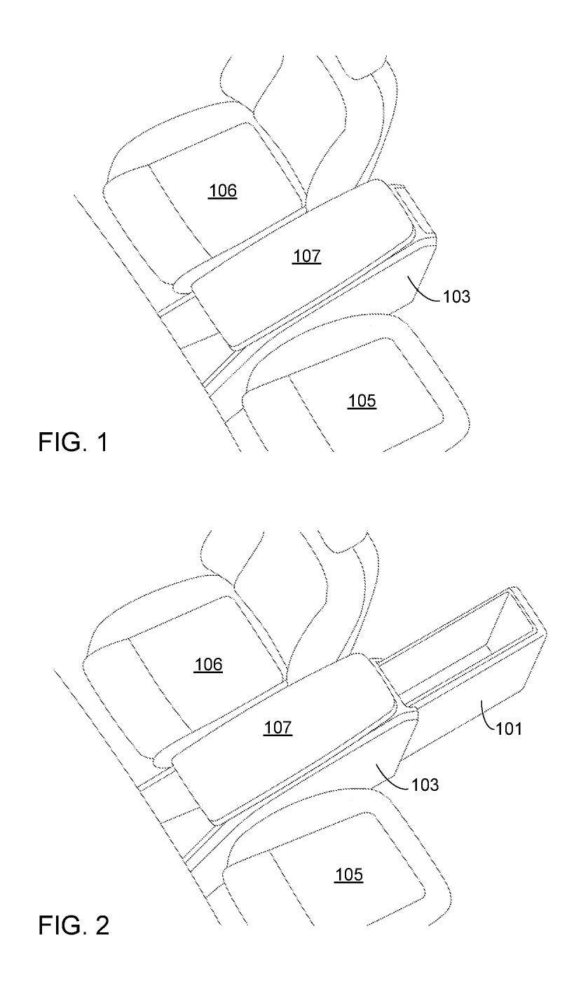

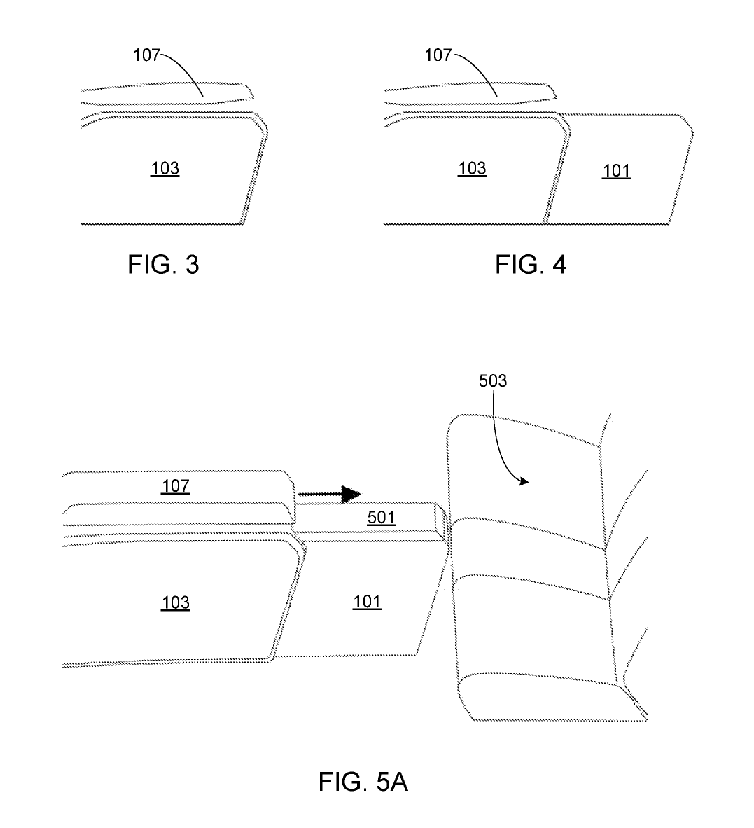

FIGS. 1 and 2 illustrate a preferred embodiment of the invention, these figures providing a perspective view of a retractable compartment 101 that slides in and out of the center console 103. FIG. 1 shows compartment 101 stored within center console 103 while FIG. 2 shows the same compartment 101 fully open and accessible. To provide locational context for compartment 101, also visible in FIGS. 1 and 2 are portions of front seats 105/106 as well as arm rest 107. Arm rest 107 may be locked in place, or hinged in order to allow front seat passengers access to compartment 101. In order to provide an unobstructed view of compartment 101 and center console 103, in these figures the seat back for seat 105 is not shown. FIGS. 3 and 4 provide a side view of center console 103 with compartment 101 fully retracted (FIG. 3) and at least partially extended (FIG. 4).

Compartment 101 can be configured to include a variety of different features. These features may be preset by the manufacturer, for example to coincide with a specific vehicle trim level or option package. Alternately, these features may be preset by the vehicle's owner, for example by being specified when the car is initially ordered from the manufacturer or dealer. Alternately these features, or at least some of these features, may be integrated into a storage compartment liner, thus allowing the end user to switch out the features included in compartment 101 based on current needs by simply switching out the compartment liner. Preferably the insertable modules are held within compartment 101 using clips, although for a semi-permanent installation a module may be held in place using bolts. The use of insertable compartment modules not only provides additional flexibility to the end user, but it also allows the compartment to be updated periodically as new modules become available from either the vehicle's manufacturer or a third party.

Regardless of whether the feature set included in compartment 101 is pre-installed or inserted into the compartment as a compartment module, the inventor envisions that compartment 101 may be used to house a variety of comfort and convenience amenities. In its simplest configuration, and as shown in FIGS. 1 and 2, compartment 101 provides a storage volume which, when closed, is hidden from sight. To add further security, a lockable lid may be added to the compartment so that even when it is in the extended position, i.e., extended from console 103, compartment access can be controlled.

In addition to providing either a secure or non-secure user storage box as described above, compartment 101 may also be outfitted with various features that can be used to transform the rear passenger compartment into a pseudo-office. For example, a fold-out desk can be included within compartment 101 so that once the compartment is extended, the desk can be un-folded. If desired, a pair of fold-out desks can be included so that both rear seat passengers may utilize this convenience. The fold-out desk(s) may include a display and/or a keyboard that can be connected to a user device, such as a laptop computer, via an integrated port (e.g., Thunderbolt, USB, DVI, HDMI, DisplayPort, etc.). Alternately, a wireless connection using any of a variety of wireless communication protocols (e.g., IEEE 802.11, long term evolution (LTE), Wi-Fi, Bluetooth, WiGig, WirelessHD, etc.) can be used to couple the user's device to the display and/or keyboard.

Compartment 101 may also be used to house any of a variety of user convenience features. For example, compartment 101 or a pre-sized module that can be inserted into compartment 101 may be thermally insulated, thus transforming compartment 101 into an ice chest that can be used to provide the passengers with easy access to chilled drinks and food. Preferably in this configuration the insulated module is removable, thus allowing easy cleaning. In at least one embodiment in addition to providing thermal insulation, an active refrigeration system may be included in compartment 101, thus eliminating the need for ice and providing further convenience to the passengers.

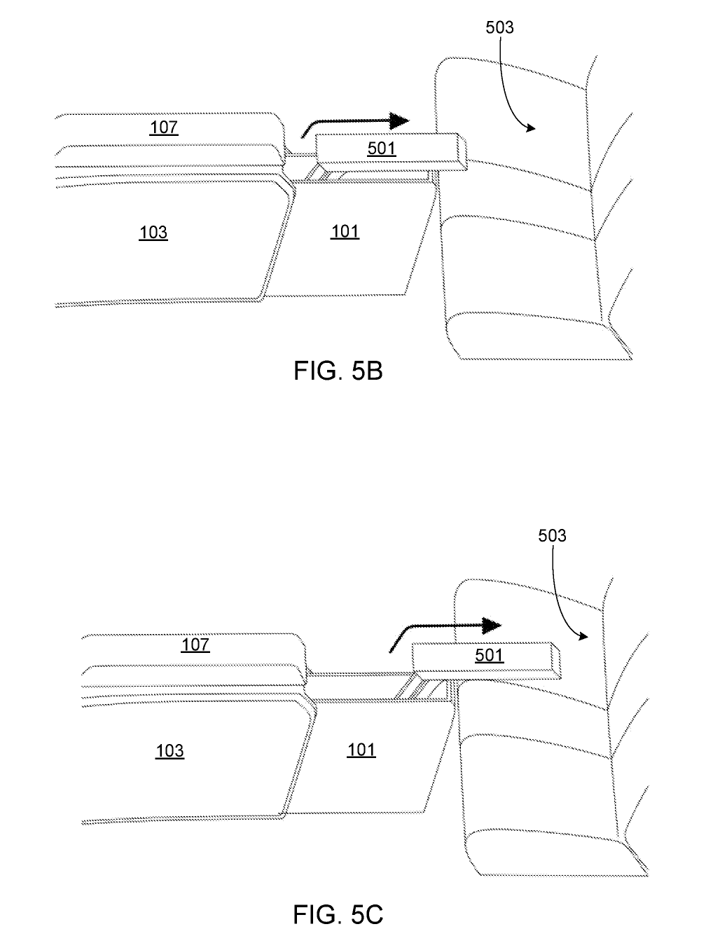

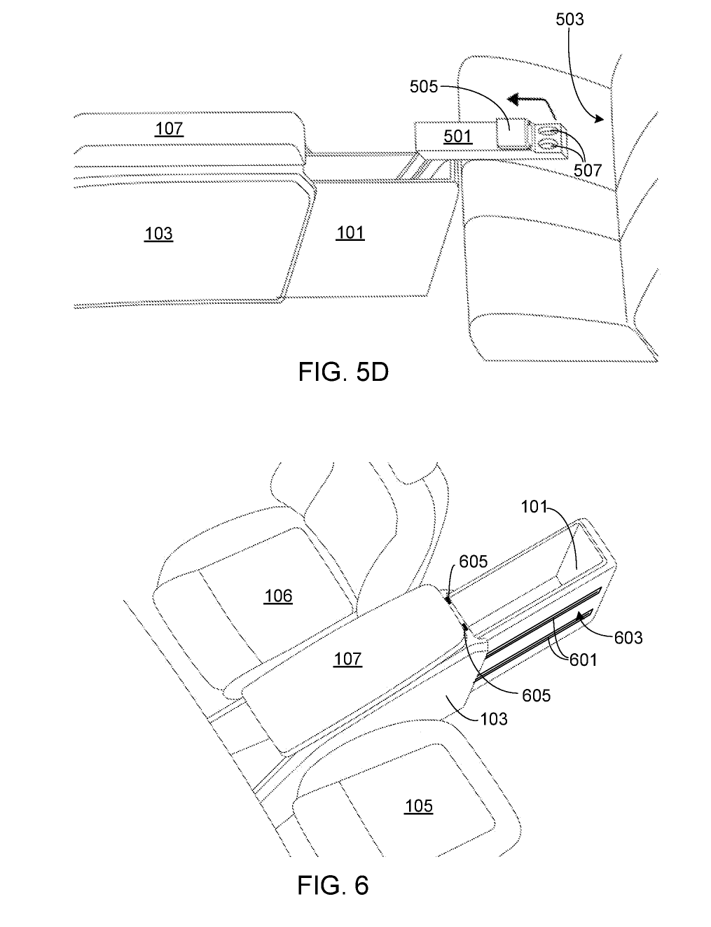

FIGS. 5A-5D illustrate an exemplary application for compartment 101. FIG. 5A illustrates the first step of deployment with compartment 101 withdrawn from center console 103. Next, and as shown in FIGS. 5B and 5C, compartment lid 501 is lifted and pulled backwards towards rear seats 503. Lastly, the rearmost portion 505 of lid 501 is flipped over, thus exposing a pair of drink holders 507 (FIG. 5D). It will be appreciated that the compartment application shown in FIGS. 5A-5D is only meant to illustrate a specific compartment configuration and, as described above, countless other configurations are envisioned by the inventor.

Various guide track mechanisms can be interposed between the vehicle and compartment 101, these guide tracks allowing the compartment to smoothly extend towards the rear seat when desired, and then be easily placed into the storage position within the central console 103 when no longer required. The guide tracks may be mounted to the vehicle's floor and the underside of compartment 101, thus providing support for heavy compartment configurations. Alternately, the guide tracks may be mounted to the bottom surface of center console 103 and the underside of compartment 101. Alternately and as shown in FIG. 6, guide tracks 601 can be interposed between the sides 603 of compartment 101 and the inner side surfaces of center console 103.

In a preferred embodiment, when the user wants to access compartment 101 they manually withdraw the compartment from center console 103. In this configuration a latch is preferably included that prevents compartment 101 from accidentally extending into the passenger cabin. Additionally a spring assembly may be used to aid in compartment withdrawal, the spring assembly applying force on the rear portion of compartment 101 or on a portion of the guide track assembly. In this configuration once the latch is released, the force of the spring assembly at least partially deploys compartment 101. Once compartment 101 is no longer needed, the user simply pushes the compartment back into the center console 103 until the latch assembly locks the compartment into its storage position.

In at least one embodiment, a non-manual electro-mechanical (e.g., motorized) or hydraulic system is used to withdraw compartment 101 from console 103 when needed, and then store compartment 101 into console 103 when it is no longer needed. Although compartment positioning switches that are coupled to the electro-mechanical or hydraulic system may be mounted anywhere within the passenger cabin, preferably they are mounted in a location that may be conveniently accessed by rear seat passengers. For example and as shown in FIG. 6, a pair of switches 605 (e.g., push buttons) may be mounted on center console 103, these switches allowing a user to either deploy the compartment or place it back into storage within console 103. Alternately, a single switch 605 may be used that cycles the compartment between the storage and deployed positions.

Systems and methods have been described in general terms as an aid to understanding details of the invention. In some instances, well-known structures, materials, and/or operations have not been specifically shown or described in detail to avoid obscuring aspects of the invention. In other instances, specific details have been given in order to provide a thorough understanding of the invention. One skilled in the relevant art will recognize that the invention may be embodied in other specific forms, for example to adapt to a particular system or apparatus or situation or material or component, without departing from the spirit or essential characteristics thereof. Therefore the disclosures and descriptions herein are intended to be illustrative, but not limiting, of the scope of the invention.

What is claimed is:

1. A passenger accessible storage system mounted within a passenger cabin of a vehicle, comprising:
a storage compartment;
a guide track assembly mounted to said storage compartment, wherein said storage compartment is movable via said guide track assembly between a first, stored position and a second, deployed position; and
a center console located between a front left seat and a front right seat, wherein said front left and front right seats comprise a first row of seats within said passenger cabin of said vehicle, and wherein said storage compartment is stored within said center console when said storage compartment is in said first, stored position, and wherein said storage compartment extends rearward towards a second row of seats within said passenger cabin of said vehicle when said storage compartment is in said second, deployed position.

2. The passenger accessible storage system of claim 1, wherein said storage compartment is only open and accessible when said storage compartment is in said second, deployed position.

3. The passenger accessible storage system of claim 1, said center console further comprising an arm rest, said arm rest hingeably coupled to said center console and movable between a first, open position and a second, closed position, wherein said storage compartment is accessible via an opening in an upper portion of said center console when said arm rest is in said first, open position and said storage compartment is in said first, stored position, and wherein said storage compartment is not accessible via said opening in said upper portion of said center console when said arm rest is in said second, closed position.

4. The passenger accessible storage system of claim 1, said storage compartment further comprising a fold-out desk, wherein said fold-out desk is integrated into said storage compartment, wherein when said storage compartment is in said first, stored position said fold-out desk is folded up and contained within said storage compartment, and wherein said fold-out desk can only be unfolded when said storage compartment is in said second, deployed position.

5. The passenger accessible storage system of claim 1, said storage compartment further comprising a display integrated into said storage compartment, wherein said display is connectable to a source device by at least one of a wired connection and a wireless connection, wherein when said storage compartment is in said first, stored position said display is in a stored position and contained within said storage compartment, and wherein said display can only be unfolded from said storage compartment and accessed when said storage compartment is in said second, deployed position.

6. The passenger accessible storage system of claim 1, said storage compartment further comprising a keyboard integrated into said storage compartment, wherein said keyboard is connectable to a source device by at least one of a wired connection and a wireless connection, wherein when said storage compartment is in said first, stored position said keyboard is in a stored position and contained within said storage compartment, and wherein said keyboard can only be unfolded from said storage compartment and accessed when said storage compartment is in said second, deployed position.

7. The passenger accessible storage system of claim 1, said storage compartment further comprising an insulated ice chest.

8. The passenger accessible storage system of claim 7, said storage compartment further comprising an active refrigeration system.

9. The passenger accessible storage system of claim 1, said storage compartment further comprising a lockable lid, wherein said storage compartment is only open and a storage compartment volume corresponding to said storage compartment is only accessible when said lockable lid is in a first, open position and said storage compartment is in said second, deployed position, and wherein said storage compartment volume is not accessible when said lockable lid is in a second, closed position.

10. The passenger accessible storage system of claim 1, said storage compartment further comprising a lid, wherein said lid is slidably coupled to said storage compartment, wherein when said storage compartment is in said second, deployed position said lid is extendible over said second row of seats.

11. The passenger accessible storage system of claim 10, said lid further comprising at least one cup holder.

12. The passenger accessible storage system of claim 1, wherein a first portion of said guide track assembly is mounted to a lower surface of said storage compartment, and wherein a second portion of said guide track assembly is mounted to a section of a floor panel corresponding to said passenger cabin of said vehicle.

13. The passenger accessible storage system of claim 1, wherein a first portion of said guide track assembly is mounted to a lower surface of said storage compartment, and wherein a second portion of said guide track assembly is mounted to a section of said center console.

14. The passenger accessible storage system of claim 1, said guide track assembly comprising a first guide track subassembly and a second guide track subassembly, wherein a first portion of said first guide track subassembly is mounted to a first side of said storage compartment, wherein a second portion of said first guide track subassembly is mounted to a first inside surface of said center console, wherein a first portion of said second guide track subassembly is mounted to a second side of said storage compartment, and wherein a second portion of said second guide track subassembly is mounted to a second inside surface of said center console.

15. The passenger accessible storage system of claim 1, further comprising a spring assembly coupled to said storage compartment, wherein said spring assembly maintains tension on said storage compartment and forces said storage compartment from said first, stored position towards said second, deployed position.

16. The passenger accessible storage system of claim 15, further comprising a latch assembly, wherein said latch assembly in a locked position maintains said storage compartment in said first, stored position, and wherein said latch assembly in an unlocked position allows said spring assembly to force said storage compartment from said first, stored position towards said second, deployed position.

17. The passenger accessible storage system of claim 1, further comprising a positioning system coupled to said storage compartment, wherein said positioning system is adjustable between a first position corresponding to said storage compartment in said first, stored position and a second position corresponding to said storage compartment in said second, deployed position.

18. The passenger accessible storage system of claim 17, said positioning system further comprising an electro-mechanical positioning system.

19. The passenger accessible storage system of claim 17, said positioning system further comprising a hydraulic positioning system.

20. The passenger accessible storage system of claim 17, further comprising a storage compartment position selector coupled to and controlling operation of said positioning system, wherein said storage compartment position selector in a first setting moves said positioning system to said first position, and wherein said storage compartment position selector in a second setting moves said positioning system to said second position.
